(19) United States
(12) Patent Application Publication
(10) Pub. No.: US 2018/0352191 A1
(43) Pub. Date: Dec. 6, 2018

(54) DYNAMIC ASPECT MEDIA PRESENTATIONS

(71) Applicant: Apple Inc., Cupertino, CA (US)

(72) Inventors: Aaron M. Eppolito, Los Gatos, CA (US); Anne E. Fink, San Jose, CA (US); James A. Queen, San Jose, CA (US); Wendy L. DeVore, Truckee, CA (US)

(73) Assignee: Apple Inc., Cupertino, CA (US)

(21) Appl. No.: 15/613,121

(22) Filed: Jun. 2, 2017

(51) Int. Cl. H04N 7/01; G06T 3/00; H04N 5/445; G06T 13/80; G06T 5/00; H04N 21/485; H04N 21/431; H04N 21/414

(52) U.S. Cl. CPC H04N 7/0117; G06T 3/0006; H04N 5/44504; G06T 13/80; H04W 88/02; G06T 5/002; H04N 21/4858; H04N 21/4312; H04N 21/41407; H04N 5/44591

(57) ABSTRACT

The disclosed embodiments are directed to dynamic aspect media presentations. In an embodiment, a method comprises: obtaining, by a mobile device, a first set of instructions for playing a media presentation in a first format, the media presentation including a composition of media assets; playing, by a media player of the mobile device, the media presentation in a media player view in the first format according to the first set of instructions; obtaining, by the mobile device, a switching event trigger signal; responsive to the switching event trigger signal: obtaining, by the mobile device, a second set of instructions for playing the media presentation in a second format that is different than the first format; and playing, by the media player, the media presentation in the media player view in the second format according to the second set of instructions.

### TECHNICAL FIELD

This disclosure relates generally to creating media presentations for display on mobile devices.

### BACKGROUND

A mobile device can be held by a user in portrait or landscape orientation. The mobile device includes sensors that can detect the orientation of the mobile device. Upon detection of the device orientation, an application running on the mobile device can rotate and resize a graphical user interface (GUI) to fully use a display aspect ratio. Many mobile devices include a media player application that plays media presentations such as, for example, a video or slideshow. Some applications can automatically create a media presentation for the user.

A media presentation can be a composition of many different media assets and special effects (FX), including video clips, digital photographs, graphics, animation and transitions. Media assets are selected by authors or automated processes to create a media presentation that is aesthetically pleasing to users. A media presentation that is optimized for a particular device orientation, however, may result in a poor viewing experience for a user who is viewing the presentation in a different device orientation.

### SUMMARY

The disclosed embodiments are directed to dynamic aspect media presentations.

In an embodiment, a method comprises: obtaining, by a mobile device, a first set of instructions for playing a media presentation in a first format, the media presentation including a composition of media assets; playing, by a media player of the mobile device, the media presentation in a media player view in the first format according to the first set of instructions; obtaining, by the mobile device, a switching event trigger signal; responsive to the switching event trigger signal: obtaining, by the mobile device, a second set of instructions for playing the media presentation in a second format that is different than the first format; and playing, by the media player, the media presentation in the media player view in the second format according to the second set of instructions.

In an embodiment, a system comprises: one or more processors; memory coupled to the one or more processors and configured to store instructions, which, when executed by the one or more processors, cause the one or more processors to perform operations comprising: obtaining a first set of instructions for playing a media presentation in a first format, the media presentation including a composition of media assets; playing, by a media player, the media presentation in a media player view in the first format according to the first set of instructions; obtaining a switching event trigger signal; responsive to the switching event trigger signal: obtaining a second set of instructions for playing the media presentation in a second format that is different than the first format; and playing, by the media player, the media presentation in the media player view in the second format according to the second set of instructions.

Other embodiments can include an apparatus, computing device and non-transitory, computer-readable storage medium.

Particular embodiments disclosed herein may provide one or more of the following advantages. Two or more dynamic aspect media presentations are created for display on a mobile device. The visual aesthetics of each presentation is optimized for a particular orientation view, such as landscape or portrait. During playback by a media player executing on the mobile device, one of the media presentations is selected for display based on a current orientation of the mobile device. Each time the device orientation changes, the media presentation also changes. In an embodiment, an animated GUI transition is used to hide the sometimes visually jarring transition between media presentations from the user. The result is an improved user experience where the user can view an aesthetically pleasing media presentation regardless of the orientation of their mobile device.

The details of one or more implementations of the subject matter are set forth in the accompanying drawings and the description below. Other features, aspects and advantages of the subject matter will become apparent from the description, the drawings and the claims.

### BRIEF DESCRIPTION OF THE DRAWINGS

FIG. 1 illustrates an example dynamic aspect media presentation, according to an embodiment.

FIGS. 2A and 2B illustrate an example GUI transition from portrait to landscape, according to an embodiment.

FIG. 2C is a plot illustrating an opacity adjustment for a snapshot of a media player view, according to an embodiment.

FIG. 2D is a plot illustrating opacity and blur radius adjustments for a blur layer, according to an embodiment.

FIG. 3A illustrates a landscape view of two media assets, according to an embodiment.

FIG. 3B illustrates a portrait view of two media assets, according to an embodiment.

FIG. 4A illustrates formatting a dynamic aspect media presentation in portrait orientation based on a display aspect ratio, according to an embodiment.

FIG. 4B illustrates formatting a dynamic aspect media presentation in landscape orientation based on a display aspect ratio, according to an embodiment.

FIGS. 5A and 5B illustrate editing a landscape media asset for a portrait view, according to an embodiment.

FIG. 6 is a block diagram of an example system for selecting and playing dynamic aspect media presentations on a mobile device, according to an embodiment.

FIG. 7 is an example process of selecting and playing a dynamic aspect media presentation on a mobile device, according to an embodiment.

FIG. 8 is an example transition process for dynamic aspect media presentations on a mobile device, according to an embodiment.

FIG. 9 is an example process of generating dynamic aspect media presentations for playback on a mobile device, according to an embodiment.

FIG. 10 is a block diagram of an example system for generating dynamic aspect media presentations, according to an embodiment.

FIG. 11 illustrates an example device architecture of a mobile device implementing the features and operations described in reference to FIGS. 1-10.

### DETAILED DESCRIPTION

### Examples of Dynamic Aspect Media Presentations

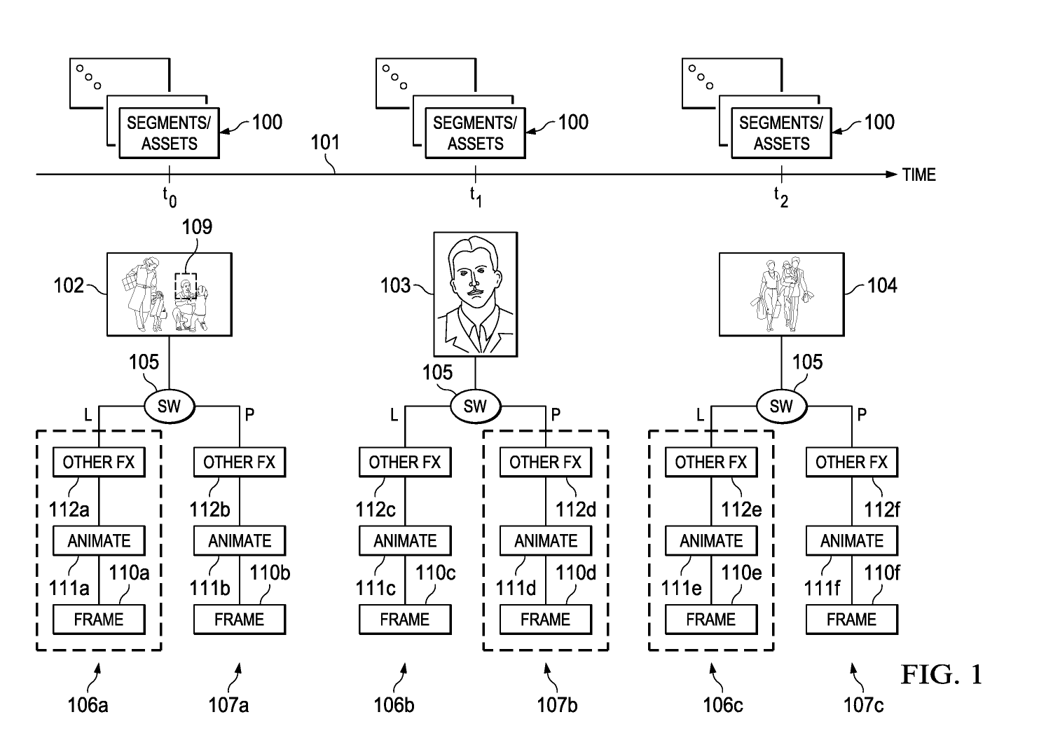

FIG. 1 illustrates an example dynamic aspect media presentation, according to an embodiment. As used herein, a media presentation can be a multimedia presentation that includes a composition of a plurality of media assets. Media assets can include but are not limited to: text, audio, images (e.g., photographs, video frames), animations, special effects, graphics, video and interactive content.

At the top of FIG. 1 is timeline 101 showing three example time points t₀, t₁, t₂. At a first time t₀, segment 102 is obtained from segments/assets 100 of a media presentation and displayed by a media player (e.g., QuickTime® Player) on a mobile device (e.g., a smartphone, tablet computer, wearable computer). At a second time t₁, segment 103 is obtained from segments/assets 100 of the media presentation and displayed by the media player. At a third time t₂, segment 104 is obtained from segments/assets 100 of the media presentation and displayed by the media player. At each time point there are two sets of instruction sets 106, 107, which describe a format (e.g., portrait view, landscape view) for how the segment is to be displayed. In this example, instruction sets 106a-106b include instructions for displaying a segment in landscape view and instruction sets 107a-107b include instructions for displaying a segment in portrait view. There can be any number of instructions sets available for execution for any number of orientations. The examples that follow, however, focus on landscape and portrait views.

During the playing of segments 102-104, software switch (SW) 105, selects one of instruction sets 106, 107 to be executed. The switch can occur while a set of instructions are executed, or between instructions, and with or without a media asset change. For example, at the first time to, the mobile device is in landscape orientation and instruction set 106a is selected by SW 105 to be executed by the media player. Instruction set 106a includes compositing instructions (e.g., a composition graph) for compositing media assets for segment 102, which can include one or more of frame instructions 110a, animation instructions 111a and other special effects (FX) instructions 112a. Frame instructions 110a specify a portion or portions of one or more media assets (e.g., photographs, video) to be composited in segment 102. Animation instructions 111a specify frames in segment 102 to be animated (if at all) and other FX instructions 112a specify other FX to apply to segment 102 (if any).

Instructions 110a, 111a, 112a, are examples of instructions that could be included in an instruction set. In practice, however, each instruction set can include more or fewer instructions. Note that in FIG. 1, “P” stands for portrait, “L” stands for landscape and the dashed boxes indicate which instruction set is being used for the segment.

Continuing with the example, at the second time t₁, and while instruction set 106a is executing, the user rotates the mobile device from landscape orientation to portrait orientation and instruction set 107b is selected by SW 105 to be executed by the media player, including executing one or more of frame instructions 110d, animation instructions 111d and other FX instructions 112d. Instruction set 107b includes a frame instruction to generate face crop 109 from a media asset used in segment 102. For example, during the display of segment 102 and the execution of instruction set 106a, the user rotates the mobile device to portrait orientation, causing frame instruction 110d to be executed, resulting in face crop 109 being displayed in portrait view in segment 103. Face crop 109 was selected as a media asset because it has an aesthetically pleasing appearance in portrait view.

At the third time t₂, and while instruction set 107b is executing, the user rotates the mobile device from portrait orientation back to landscape orientation and instruction set 106c is selected by SW 105 to be executed by the media player, including executing one or more of frame instructions 110e, animation instructions 111e and other FX instructions 112e.

Segments, media assets and instructions sets can be stored on the mobile device and/or downloaded from a network-based media server. As described in more detail below, the media assets (e.g., photographs, video clips) used in segments can be edited and animated in a manner to ensure an aesthetically pleasing display in landscape or portrait views. For example, animation can differ between views to best highlight the chosen presentation for each view and content.

In an embodiment, instructions sets are built for each orientation and SW switch 105 between the instruction sets as described above. In other embodiments, the instruction sets are generated on demand. In general, system 100 composites a media presentation for a plurality of display sizes or aspect ratios with dynamic instantaneous switching, where one of the switch triggers is rotation of the mobile device. Another switch trigger could be a change in display size or aspect ratio made by a user or application. For example, the user or application may choose a different display size or aspect ratio for exporting a media presentation from the mobile device. In an embodiment, the system may choose alternate media assets between a plurality of media presentations, where the system has determined that the alternate media assets are similar to the media assets in the presentations but more appropriate for the specific presentation. For example, in the case where the user has shot both a landscape and portrait version of the same object, the system would choose the appropriate version between the instruction sets.

### Example GUI Transition Effect

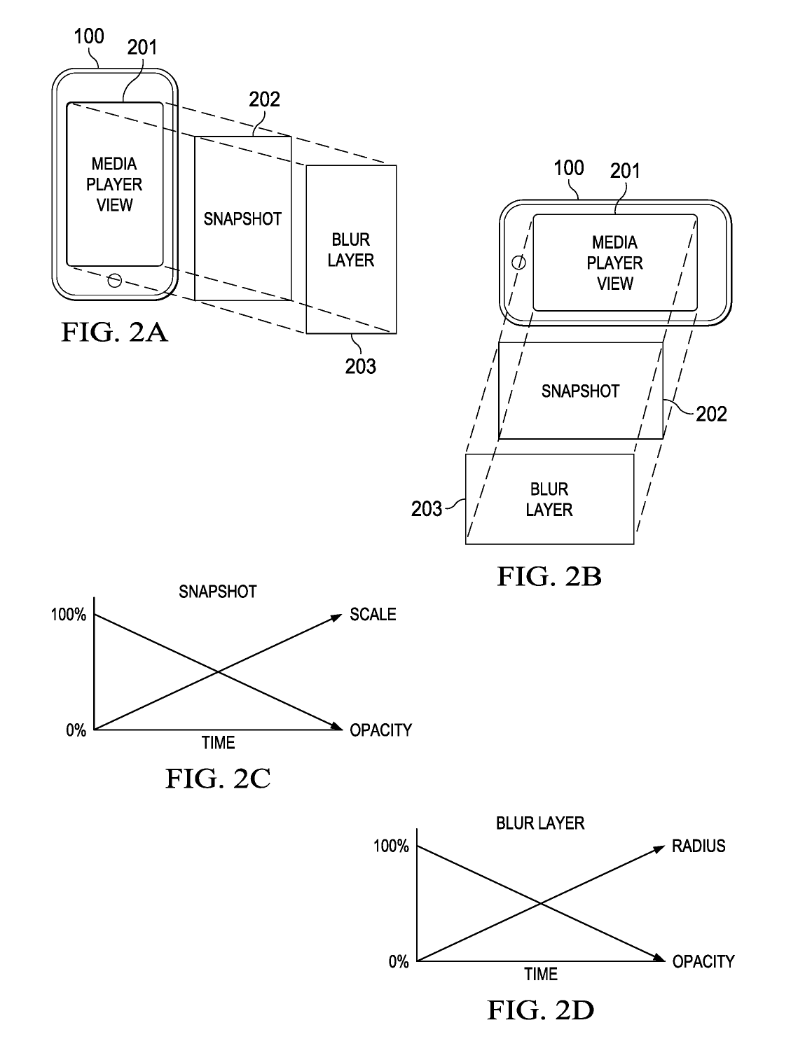

FIGS. 2A and 2B illustrate an example GUI transition from portrait to landscape, according to an embodiment. To improve the visual aesthetics during a transition between media transitions, a GUI transition effect is applied to hide artifacts resulting from the transition that could be visually jarring to the user.

In an embodiment, media player view 201 is created by a media player for displaying media. Upon detection of mobile device 100 orientation, an orientation signal is generated (e.g., by the mobile device operating system) that indicates the orientation of mobile device 100. In the example shown in FIGS. 2A and 2B, mobile device 100 is rotated by a user from portrait (FIG. 2A) to landscape (FIG. 2B). Upon receipt of the orientation signal, snapshot 202 (an image capture) of media player view 201 is composited over media player view 201. Additionally, blur layer 203 (e.g., a Gaussian blur layer) is composited over snapshot 202. The blur layer provides a blur effect that samples neighboring pixel values around a pixel and assigns to the pixel a new value that is the average of the sampled neighboring pixel values. The blurriness can be increased by increasing the radius of the sample area (increasing the number pixels in the average).

During the GUI transition of the composite of media player view 201, snapshot 202 and blur layer rotate together 90 degrees and scale from a portrait display aspect ratio to a landscape display aspect ratio. Snapshot 202 and blur layer 203 are used together hide the visually jarring artifacts that may occur when transitioning between media presentations. During the rotation and scaling, the blur radius of the blur layer increases linearly (becomes more blurred) and the opacity of snapshot 202 and blur layer 203 decrease linearly (become more transparent). FIG. 2C is a plot illustrating a linear opacity adjustment for snapshot 202 and FIG. 2D is a plot illustrating a linear opacity and blur radius adjustment for blur layer 203.

In an embodiment, an alternative to the rotation transition described above can be used, including but not limited to: removing the blur layer, animating a zoom to a crop while rotating and using a second player instead of a snapshot.

### Example Dynamic, Aspect-Aware Content Selection

The creation of a dynamic, aspect-aware media presentation includes analyzing various media assets in a collection of media assets using various algorithms, editing the media assets based on results of the analysis and other metadata (e.g., user-defined metadata tags), compositing the edited media assets into frames using layout rules and optionally applying transitions, animation and other FX to the frames.

In an embodiment, an automated process analyzes the content and metadata of a corpus of media assets to create one or more collections of media assets from which media presentations (e.g., video presentations) can be created. Various methods can be used, alone or in combination, to match media assets in the corpus (e.g., videos, photographs) to a collection, including but not limited to: location-bounded collections (e.g., media assets captured within a geographic region defined by a radial distance or geofence), time-bounded collections (e.g., media assets captured within a particular time range and/or date range), time-bounded and location-bounded collections (e.g., media assets associated with holidays and events at the family home), content-defined collections (e.g., media assets containing people smiling), user-metadata based collections (e.g., media assets having user-defined metadata tags) and people-based collections (e.g., media assets that include the face of a particular individual or individuals). In an embodiment, the quality of media assets is considered when forming collections, such as whether the assets are blurry or noisy. In an embodiment, the quantity of media assets is considered when forming collections.

In an embodiment, a collection of media assets can be created by matching attributes of a template collection, such as a theme (e.g., holidays, smiling people), to content and/or metadata of media assets in a corpus of media assets. For example, if a template collection has a theme of “Christmas”, the corpus of media assets can be searched to find media assets that are tagged with metadata and/or include content that matches the “Christmas” theme. The matching media assets can be included in the template collection and used to generate orientation-based, media presentations. Additional techniques for grouping image assets into templates and generating media presentations is described in co-pending U.S. Provisional Patent Application No. 62/235,550, for “Novel Media Compositing Application,” which provisional patent application is hereby incorporated by reference in its entirety.

Some media assets (e.g., photographs) can be captured in landscape and portrait orientations. Contained in each media asset, are objects of interest which can be identified using various algorithms, such as saliency detection, face recognition and/or user-defined metadata tags. Saliency detection is a known image analysis technique that attempts to determine where the average viewer will look at a photograph to identify an object of interest. Face recognition detects faces in photographs or video frames using a feature vector describing geometric characteristics of a human face. The media assets can be edited to fit into a particular orientation view to ensure that the objects of interest are the primary focus in the view and not lost off-screen. For example, if the title of a media presentation is “Natalie—Christmas 2017”, media assets that include Natalie's face can be used to create both portrait and landscape media presentations. In some cases, a media asset that was captured in portrait orientation is used in a landscape media presentation and vice-versa. Typically, a portrait media asset cannot be scaled to fit the landscape aspect ratio without changing the aspect ratio of the media asset, which may result in a distorted image. In other cases, a media asset that was captured in landscape orientation may not fit in a portrait aspect ratio with editing (e.g., image cropping). The techniques described below allow an automated process to choose any media asset in a collection, regardless of how the media asset was captured, and include it in either a portrait or landscape view without compromising the visual aesthetics of the overall media presentation.

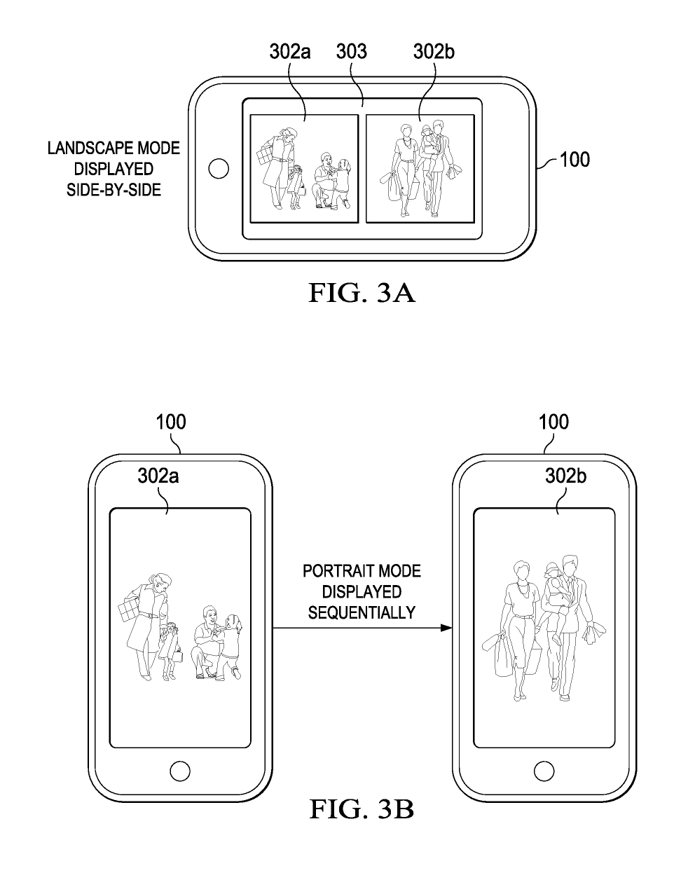

FIG. 3A illustrates a landscape presentation of two media assets (e.g., photos), according to an embodiment. In this example embodiment, a sequence of portrait media assets 302a, 302b are displayed side-by-side in a landscape media presentation on mobile device 100. Media assets 302a, 302b can be the same or different media assets. In general N (where N is a positive integer greater than one) portrait media assets can be displayed side-by-side in a landscape view depending on the aspect ratio of the display area. This technique (referred to as “n-up” display) allows the automated process to pair portrait media assets that are strongly related to each other (e.g., a burst of photographs) in a single view. This technique determines when media assets or portions of media assets can be displayed together on screen and whether the media assets should be zoomed out (and by how much) to ensure that important object of interest in the media assets are included in the presentation. This technique can also be used to divide a single landscape media asset into N portrait media assets for display in a single landscape view. For example, if Natalie and her toy are at opposite ends of a landscape photograph, a cropped image of Natalie's face can be placed next to a cropped image of the toy. Black areas 303 around media assets 302a, 302b can be filled in with a blur, another color or other FX to create a more visually aesthetic composition. For example, a blur layer can be applied to the background under the media assets to fill in the black areas around the media assets.

In an embodiment, a processed union of important spatial regions in a media asset are used to determine the positioning of the media asset in multiple orientations. In another embodiment, a processed union of important regions of interest in the N media assets is used to determine the potential for the combination of those N media assets into a composition.

FIG. 3B illustrates a portrait presentation of two media assets (e.g., photos), according to an embodiment. The media assets 302a, 302b shown in FIG. 3A can be displayed sequentially in a portrait media presentation. Media assets 302a, 302b can be the same or different media assets. In general, a sequence of N related media assets can be displayed in this manner. As in FIG. 3A, black areas around the media asset can be filled in with a blur, another color or other FX to create a more visually aesthetic composition.

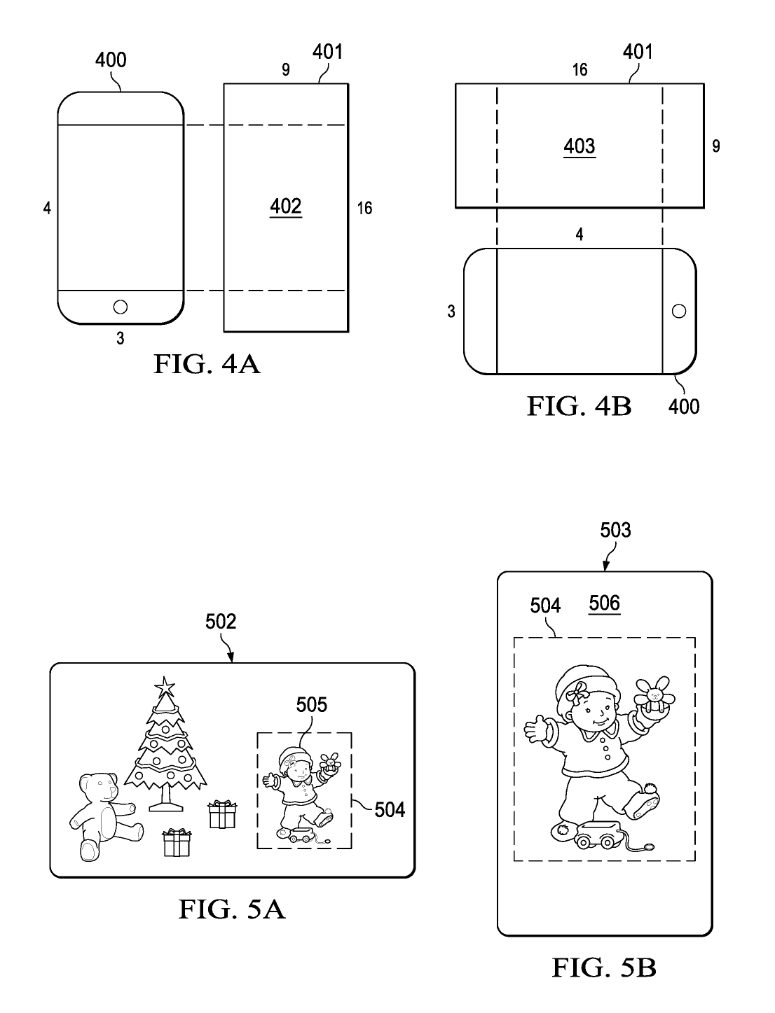

FIGS. 4A and 4B illustrate formatting a media presentation in portrait and landscape device orientation, respectively, based on display aspect ratio, according to an embodiment. In an embodiment, a user may want to view the same media presentation on different devices having different display aspect ratios. For example, device 400 (a tablet computer) has a usable display 402 with a 4:3 aspect ratio and device 401 (a smartphone) has a usable display 403 with a 16:9 aspect ratio. To ensure a consistent user viewing experience across devices 400, 401, and regardless of the mobile device orientation, a dynamic aspect media presentation can be adjusted to ensure that objects of interest that are visible on device 400 are also visible on device 401. For example, if the object of interest is a child, device 400 may display the child front and center. However, when the same media presentation is played on device 400 the child may be off-center or have a portion of the child's body cut off. By editing (e.g., cropping) the media presentation based on the display aspect ratio, a consistent user viewing experience can be maintained from device to device regardless of display aspect ratio and regardless of the device orientation.

In an embodiment, in addition to formatting for display aspect ratio, a media presentation can be formatted to avoid other on-screen elements like physical device characteristics, titles, etc.

FIGS. 5A and 5B illustrate editing a landscape media asset for a portrait media view, according to an embodiment. In this example, a landscape media asset completely fills landscape frame 502, as shown in FIG. 5A. The landscape media asset includes child 505 playing with a toy in a Christmas scene complete with a tree and presents. After analyzing the media asset (which was included in a Christmas collection), child 505 is selected as the object of interest. For example, in an embodiment a salience detection algorithm can determine that the child 505 is an object of interest to be cropped for inclusion into a portrait view. In another example, user-defined metadata could reveal that child 505 is the object of interest and face recognition can be used to identify child 505 in the media asset. Some examples of face recognition algorithms include but are not limited to: principal component analysis using eigenfaces, linear discriminant analysis, elastic bunch graph matching using the Fisherface algorithm, the hidden Markov model, the multilinear subspace learning using tensor representation, and the neuronal motivated dynamic link matching. Once the face is detected, image crop 504 of the child can be generated and placed in portrait view 503. Black areas 506 can be filled with blur, another color or other FX to improve the visual appearance of the composition.

### Example Dynamic Aspect Media Player

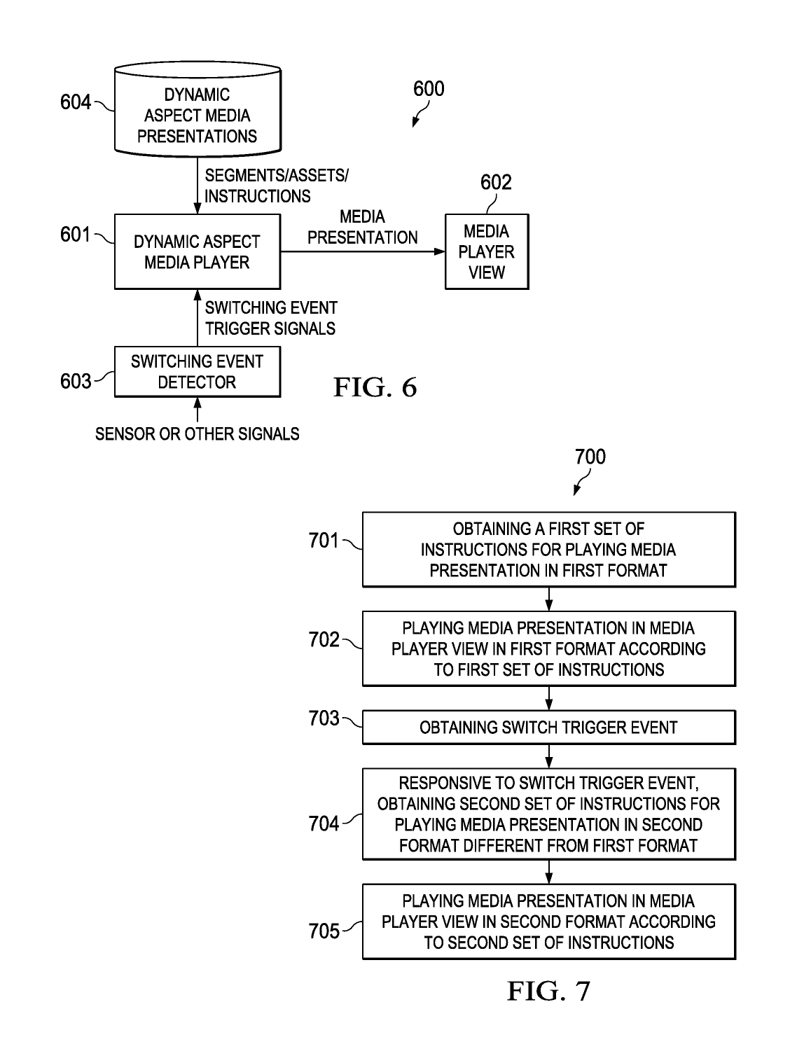

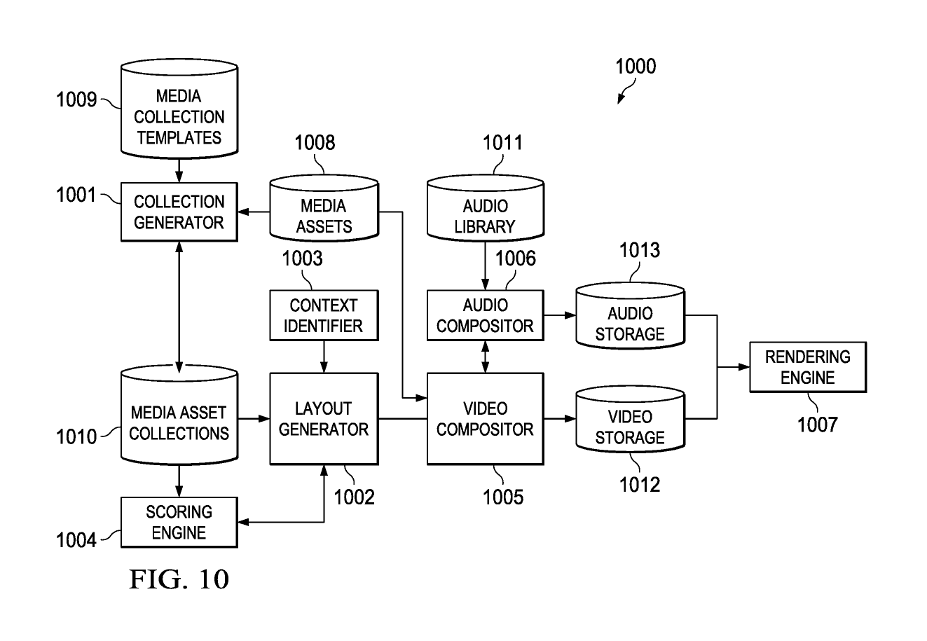

FIG. 6 is a block diagram of an example system 600 for selecting and playing dynamic aspect media presentations on a mobile device, according to an embodiment. System 600 includes dynamic aspect media player 601, media player view 602, switching event detector 603 and dynamic aspect media presentation database 604. As described in previous sections, and as described further in reference to FIGS. 9 and 10, dynamic aspect media presentations can be created from media assets prior to presentation by media player 601. In an embodiment, media player 601 is an application that receives a switching event trigger signal from switching event detector 603 and selects one of two instruction sets for presenting a segment in media player view 602. In an embodiment, switching event detector 603 receives sensor data from for example, an accelerometer, gyro sensor or magnetometer, and generates a switching event trigger signal indicating the orientation of the mobile device. In an embodiment, switching event detector 603 receives other switching event trigger signals, such as a signal from an application or operating system that indicates a size or aspect ratio of a device screen or media player view. For example, the user or an application may export the media presentation to a device with a different screen size or aspect ratio, such as a television screen or computer monitor. When the export is requested, a switching event trigger signal can be generated to trigger a different set of instructions to be selected for displaying the media presentation.

### Example Processes

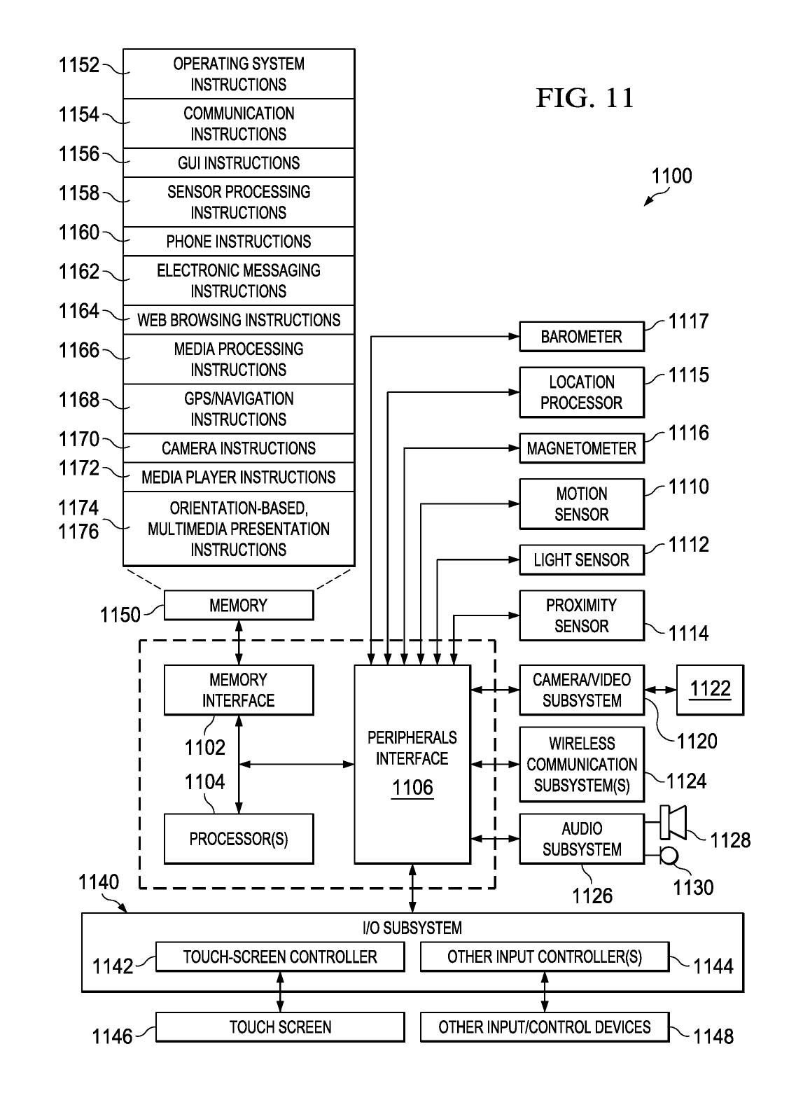

FIG. 7 is an example process 700 of obtaining and playing a dynamic aspect media presentation on a mobile device, according to an embodiment. Process 700 can be implemented using the device architecture described in reference to FIG. 11.

Process 700 includes obtaining a first set of instructions for playing a media presentation in a first format (701), playing, by a media player, the media presentation in a media player view in the first format according to the first set of instructions (702) and obtaining a switching event trigger signal (703). Responsive to the switching event trigger signal, process 700 continues by obtaining a second set of instructions for playing the media presentation in a second format that is different than the first format (704), and playing, by the media player, the media presentation in the media player view in the second format according to the second set of instructions (705). In an embodiment, the switching event trigger signal can be generated in response to sensor data from, for example, an accelerometer, gyro sensor or magnetometer that indicates the orientation of the mobile device. In an embodiment, the switching event trigger signal can be generated by an application or operating system that indicates a size or aspect ratio of a device screen or media player view. For example, the user or an application may export the media presentation to a device with a different screen size or aspect ratio, such as a television screen or computer monitor. When the export is requested, a switching event trigger signal can be generated to trigger the second set of instructions to be selected for displaying the media presentation. The first and second set of instructions can include instructions for framing (e.g., cropping), animating (e.g., panning and zooming) and other special effects. Each instruction set is designed to generate a view for a particular format (e.g., portrait or landscape view) that is aesthetically pleasing to a viewer.

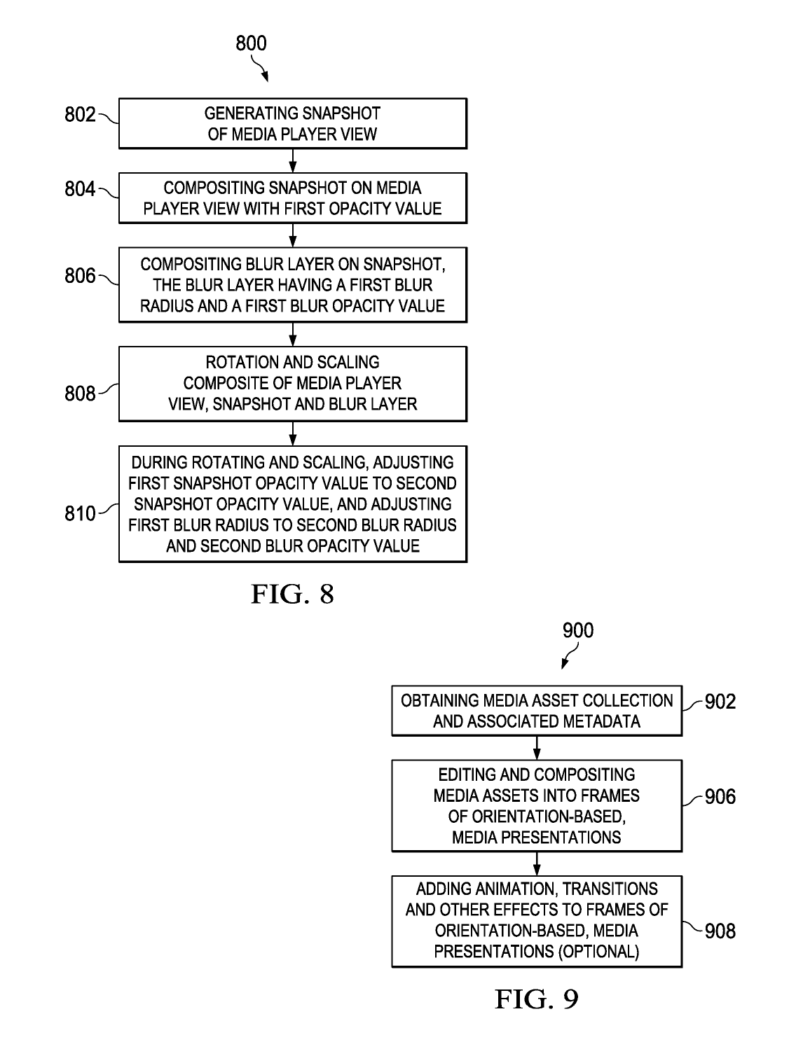

FIG. 8 is an example GUI transition process 800 for dynamic aspect media presentations on a mobile device, according to an embodiment. Process 800 can be implemented using the device architecture described in reference to FIG. 11.

Process 800 can begin by generating a snapshot of a media player view (802), compositing the snapshot on the media player view with a first opacity value (804) and compositing a blur layer on the snapshot with a first blur radius and a first blur opacity value (806). The snapshot is a still image of the current content displayed by the media player view prior to initiation of the GUI transition. The blur layer can be a Gaussian blur layer with an adjustable blur radius and adjustable opacity.

Process 800 continues by rotating and scaling of the media player view, snapshot and blur layer (808), and during the rotation and scaling, adjusting the first snapshot opacity value to a second snapshot opacity value, and adjusting the first blur radius and the first blur opacity value to a second blur radius and a second blur opacity value (810). For example, during rotation and scaling, the blur radius of the blur layer can be increased linearly while simultaneously decreasing linearly the opacity of the snapshot and blur layer.

FIG. 9 is an example process 900 of generating dynamic aspect media presentations for playback on a mobile device, according to an embodiment. Process 900 can be implemented using the device architecture described in reference to FIG. 11.

Process 900 can begin by obtaining a media asset collection and associated metadata (902) and editing and compositing media assets in the collection into frames of dynamic aspect media presentations (906). In an embodiment, an automated process analyzes the content and metadata of media assets to define one or more collections of media assets from which media presentations can be created. Various methods can be used, alone or in combination, to match media assets to a collection, including but not limited to: location-bounded collections, time-bounded collections, time-bounded and location-bounded collections, content-defined collections, user-metadata based collections and people-based collections. Editing can include image cropping objects of interest from image assets identified through image analysis (e.g., salience detection, face detection) and/or the metadata. In an embodiment, media assets can be composited in a frame in a manner that ensures that objects of interest are displayed prominently in the frame (e.g., front and center) and avoid cutting off a portion of the media asset. Some examples of orientation-based layouts include placing N media assets side-by-side in a landscape view or sequentially in multiple portrait views.

Process 900 continues by optionally adding animation, transitions and other FX to each media presentation (908). In an embodiment, transitions can be added (e.g., fade in/out, dissolve, iris) and animation (e.g., panning and zooming effect) can be added to the frames to provide a Ken Burns effect. For example, panning and zooming can be added to portrait and landscape media presentations in a manner that maintains continuity and flow after the transitioning. This can be accomplished by panning in the same direction at the same speed and starting the panning effect at the same location in corresponding frames of the orientation-based, media presentations. Likewise, zooming can start at the same location in the corresponding frames and at same the same zoom level or depth, and also zoom at same zoom rate in each orientation-based, media presentation.

FIG. 10 is a block diagram of an example system 1000 for generating dynamic aspect media presentations, according to an embodiment. System 1000 can be implemented on a mobile device (e.g., smartphone, tablet computer, wearable computer, notebook computer) or a network-based media server. System 1000 includes collection generator 1001, layout generator 1002, context identifier 1003, scoring engine 1004, video compositor 1005, audio compositor 1006 and rendering engine 1007. To perform their respective operations, these modules of system 1000 access media asset storage 1008, media collection template storage 1009, media asset collection storage 1010, audio library 1011, video presentation storage 1012 and audio storage 1013.

In some embodiments, collection generator 1001 and layout generator 1002 perform an automated process that analyzes media assets (e.g., analyzes the content and/or metadata of the media assets) to define one or more collections and produces multiple dynamic aspect media presentations. In performing their respective operations, these modules in some embodiments use context identifier 1003 and scoring engine 1004. More specifically, to define the collections, collection generator 1001 uses one or more media asset collection templates (hereinafter also referred to as “templates”) in media collection template storage 1009 to associate each media asset stored in media asset storage 1008 with one or more template instances. In some embodiments, a template in media collection template storage 1009 is defined by reference to a set of media matching attributes. Collection generator 1001 compares a template's attribute set with the content and/or metadata of the media assets to identify media assets that match the template attributes. When a sufficient number of media assets match the attribute set of a template, system 1000 defines a template instance by reference to the matching media assets, and stores this template instance in media asset collection storage 1010. In some embodiments, a template instance includes a list of media asset identifiers that identify the media assets that matched the instance's template attribute set.

In some embodiments, collection generator 1001 defines multiple template instances for a template. For instance, the templates can include location-bounded templates (e.g., videos and/or photos captured within a geographic region with a particular radius), (2) time-bounded templates (e.g., videos and/or photos captured within a particular time range and/or date range), (3) time-bounded and location-bounded templates (e.g., Christmas in Tahoe), (4) content-defined templates (e.g., videos and/or photos containing people smiling) and (5) user-defined metadata based templates (e.g., media assets from photo albums created by the user, media assets shared by a user with others, media assets having particular user-defined metadata tags). Collection generator 1001 stores the definition of the template instances that it generates in media as set collection storage 1010. In an embodiment, collection generator 1001 repeats its collection operation to update the template instance definitions in media asset collection storage 1010. For instance, collection generator 1001 can repeat its collection operation periodically (e.g., every hour, six hours, twelve hours, twenty-four hours). Conjunctively, or alternatively, collection generator 1001 performs its collection operation in response to an application or a user request.

In some embodiments, collection generator 1001 performs its collection operation each time a new media asset is stored, or a certain number of media assets are stored, in media asset storage 1008. For example, in some embodiments, system 1000 is implemented on a mobile device that captures a variety of media assets data (e.g., still photos, burst-mode photos, video clips). Each time the mobile device captures a media asset (e.g., a photo, a video clip, etc.), collection generator 1001 tries to associate the captured media asset with one or more template instances.

Based on a template definition, layout generator 1002 generates user interface (UI) layouts that identify the defined template instances as media asset collections for which system 1000 can display orientation-based media presentations. At any given time, layout generator 1002 generates a UI layout that identifies a subset of the defined template instance that would be contextually relevant to a user of the device at that time based on contextual attributes provided by context identifier 1003 (e.g., the current time, a future time, the current location of the device, a future predicted location of the device based on future events) and one or more scores computed by scoring engine 1004. In an embodiment, an aggregate score is calculated by scoring engine 1004 as a weighted sum of multiple scores. Some examples of scores included in the aggregate score, include but are not limited to: a contextual score (e.g., based on contextual attributes), a quality score (e.g., based on the quality of media assets) and a quantity score (e.g., based on the number media assets). Further details regarding the calculation of scores are described in co-pending U.S. Provisional Patent Application No. 62/235,550.

System 1000 can generate multiple dynamic aspect media presentations and store them in video storage 1012. Responsive to a switching event trigger signal of a mobile device, one of the presentations stored in video storage, and corresponding audio in storage 1013, are rendered by rendering engine 1007. In an embodiment, a fully rendered file is generated for each device orientation for subsequent playback by a media player of a mobile device.

### Exemplary Mobile Device Architecture

FIG. 11 illustrates an example device architecture 1100 of a mobile device implementing the features and operations described in reference to FIGS. 1-10. Architecture 1100 can include memory interface 1102, one or more data processors, image processors and/or processors 1104 and peripherals interface 1106. Memory interface 1102, one or more processors 1104 and/or peripherals interface 1106 can be separate components or can be integrated in one or more integrated circuits. The various components in architecture 1100 can be coupled by one or more communication buses or signal lines.

Sensors, devices and subsystems can be coupled to peripherals interface 1106 to facilitate multiple functionalities. For example, one or more motion sensors 1110, light sensor 1112 and proximity sensor 1114 can be coupled to peripherals interface 1106 to facilitate motion sensing (e.g., acceleration, rotation rates), lighting and proximity functions of the mobile device. Location processor 1115 can be connected to peripherals interface 1106 to provide geopositioning. In some implementations, location processor 1115 can be a GNSS receiver, such as a Global Positioning System (GPS) receiver chip. Electronic magnetometer 1116 (e.g., an integrated circuit chip) can also be connected to peripherals interface 1106 to provide data that can be used to determine the direction of magnetic North. Electronic magnetometer 1116 can provide data to an electronic compass application. Motion sensor(s) 1110 can include one or more accelerometers and/or gyros configured to determine change of speed and direction of movement of the mobile device. Barometer 1117 can be configured to measure atmospheric pressure around the mobile device.

Camera subsystem 1120 and an optical sensor 1122, e.g., a charged coupled device (CCD) or a complementary metal-oxide semiconductor (CMOS) optical sensor, can be utilized to facilitate camera functions, such as capturing photographs and recording video clips.

Communication functions can be facilitated through one or more wireless communication subsystems 1124, which can include radio frequency (RF) receivers and transmitters (or transceivers) and/or optical (e.g., infrared) receivers and transmitters. The specific design and implementation of the communication subsystem 1124 can depend on the communication network(s) over which a mobile device is intended to operate. For example, architecture 1100 can include communication subsystems 1124 designed to operate over a GSM network, a GPRS network, an EDGE network, a Wi-Fi™ or Wi-Max™ network and a Bluetooth™ network. In particular, the wireless communication subsystems 1124 can include hosting protocols, such that the mobile device can be configured as a base station for other wireless devices.

Audio subsystem 1126 can be coupled to a speaker 1128 and a microphone 1130 to facilitate voice-enabled functions, such as voice recognition, voice replication, digital recording and telephony functions. Audio subsystem 1126 can be configured to receive voice commands from the user.

I/O subsystem 1140 can include touch surface controller 1142 and/or other input controller(s) 1144. Touch surface controller 1142 can be coupled to a touch surface 1146 or pad. Touch surface 1146 and touch surface controller 1142 can, for example, detect contact and movement or break thereof using any of a plurality of touch sensitivity technologies, including but not limited to capacitive, resistive, infrared and surface acoustic wave technologies, as well as other proximity sensor arrays or other elements for determining one or more points of contact with touch surface 1146. Touch surface 1146 can include, for example, a touch screen. I/O subsystem 1140 can include a haptic engine or device for providing haptic feedback (e.g., vibration) in response to commands from a processor.

Other input controller(s) 1144 can be coupled to other input/control devices 1148, such as one or more buttons, rocker switches, thumb-wheel, infrared port, USB port and/or a pointer device such as a stylus. The one or more buttons (not shown) can include an up/down button for volume control of speaker 1128 and/or microphone 1130. Touch surface 1146 or other controllers 1144 (e.g., a button) can include, or be coupled to, fingerprint identification circuitry for use with a fingerprint authentication application to authenticate a user based on their fingerprint(s).

In one implementation, a pressing of the button for a first duration may disengage a lock of the touch surface 1146; and a pressing of the button for a second duration that is longer than the first duration may turn power to the mobile device on or off. The user may be able to customize a functionality of one or more of the buttons. The touch surface 1146 can, for example, also be used to implement virtual or soft buttons and/or a virtual touch keyboard.

In some implementations, the mobile device can present recorded audio and/or video files, such as MP3, AAC and MPEG files. In some implementations, the mobile device can include the functionality of an MP3 player. Other input/output and control devices can also be used.

Memory interface 1102 can be coupled to memory 1150. Memory 1150 can include high-speed random access memory and/or non-volatile memory, such as one or more magnetic disk storage devices, one or more optical storage devices and/or flash memory (e.g., NAND, NOR). Memory 1150 can store operating system 1152, such as iOS, Darwin, RTXC, LINUX, UNIX, OS X, WINDOWS, or an embedded operating system such as VxWorks. Operating system 1152 may include instructions for handling basic system services and for performing hardware dependent tasks. In some implementations, operating system 1152 can include a kernel (e.g., UNIX kernel).

Memory 1150 may also store communication instructions 1154 to facilitate communicating with one or more additional devices, one or more computers and/or one or more servers, such as, for example, instructions for implementing a software stack for wired or wireless communications with other devices. Memory 1150 may include graphical user interface instructions 1156 to facilitate graphic user interface processing; sensor processing instructions 1158 to facilitate sensor-related processing and functions; phone instructions 1160 to facilitate phone-related processes and functions; electronic messaging instructions 1162 to facilitate electronic-messaging related processes and functions; web browsing instructions 1164 to facilitate web browsing-related processes and functions; media processing instructions 1166 to facilitate media processing-related processes and functions; GNSS/Location instructions 1168 to facilitate generic GNSS and location-related processes and instructions; and camera instructions 1170 to facilitate camera-related processes and functions. Memory 1150 further includes media player instructions 1172, and orientation-based, media presentation instructions 1174 for performing the features and processes described in reference to FIGS. 1-10. The memory 1150 may also store other software instructions (not shown), such as security instructions, web video instructions to facilitate web video-related processes and functions and/or web shopping instructions to facilitate web shopping-related processes and functions. In some implementations, the media processing instructions 1166 are divided into audio processing instructions and video processing instructions to facilitate audio processing-related processes and functions and video processing-related processes and functions, respectively.

Each of the above identified instructions and applications can correspond to a set of instructions for performing one or more functions described above. These instructions need not be implemented as separate software programs, procedures, or modules. Memory 1150 can include additional instructions or fewer instructions. Furthermore, various functions of the mobile device may be implemented in hardware and/or in software, including in one or more signal processing and/or application specific integrated circuits.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., SWIFT, Objective-C, C#, Java), including compiled or interpreted languages, and it can be deployed in any form, including as a stand-alone program or as a module, component, subroutine, a browser-based web application, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random-access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor or a retina display device for displaying information to the user. The computer can have a touch surface input device (e.g., a touch screen) or a keyboard and a pointing device such as a mouse or a trackball by which the user can provide input to the computer. The computer can have a voice input device for receiving voice commands from the user.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

A system of one or more computers can be configured to perform particular actions by virtue of having software, firmware, hardware, or a combination of them installed on the system that in operation causes or cause the system to perform the actions. One or more computer programs can be configured to perform particular actions by virtue of including instructions that, when executed by data processing apparatus, cause the apparatus to perform the actions.

One or more features or steps of the disclosed embodiments may be implemented using an Application Programming Interface (API). An API may define on or more parameters that are passed between a calling application and other software code (e.g., an operating system, library routine, function) that provides a service, that provides data, or that performs an operation or a computation. The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API. In some implementations, an API call may report to an application the capabilities of a device running the application, such as input capability, output capability, processing capability, power capability, communications capability, etc.

As described above, some aspects of the subject matter of this specification include gathering and use of data available from various sources to improve services a mobile device can provide to a user. The present disclosure contemplates that in some instances, this gathered data may identify a particular location or an address based on device usage. Such personal information data can include location-based data, addresses, subscriber account identifiers, or other identifying information.

The present disclosure further contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

In the case of advertisement delivery services, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publically available information.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

What is claimed is:

1. A method comprising:
obtaining, by the mobile device, a first set of instructions for playing a media presentation in a first format, the first format including a first composition of media assets based on a first orientation view;
playing, by a media player of the mobile device, the media presentation in a media player view in the first format according to the first set of instructions;
obtaining, by the mobile device, a switching event trigger signal indicating a change in orientation of the mobile device;
responsive to the switching event trigger signal:
obtaining, by the mobile device, a second set of instructions for playing the media presentation in a second format, the second format including a second composition of media assets that is different than the first composition of media assets, the second composition of media assets based on a second orientation view that is different than the first orientation view; and
playing, by the media player, the media presentation in the media player view in the second format according to the second set of instructions.

2. (canceled)

3. The method of claim 1, wherein the switching event trigger signal is a change in size or aspect ratio of the media player view.

4. The method of claim 1, wherein the first or second set of instructions include instructions for at least one of framing, animating or applying special effects to at least one media asset in the media presentation.

5. The method of claim 4, wherein the first or second set of instructions include framing instructions for using metadata or unions of spatial regions in the at least one media asset to position an object of interest in the at least one media asset in a composition for display in the media player view.

6. The method of claim 4, wherein the first or second set of instructions include framing instructions for using metadata or unions of spatial regions in two or more media assets to determine a potential for combining the two or more media assets in the media player view.

7. The method of claim 6, wherein the potential for combining the two or more media assets in the media player view includes the potential to display the two or more media assets side-by-side in the media player view.

8. The method of claim 1, wherein the first or second set of instructions include animating instructions for animating one or more media assets of the media presentation to highlight an object of interest in the one or more media assets.

9. The method of claim 1, wherein responsive to the switching event trigger signal, the method further comprises:
generating a snapshot of the media player view;
compositing the snapshot on the media player view, the snapshot having a first snapshot opacity value;
compositing a blur layer on the snapshot, the blur layer having a first blur radius and a first blur opacity value;
rotating and scaling the composite of the player view, the snapshot and the blur layer; and
during the rotating and scaling, adjusting the first snapshot opacity value to a second snapshot opacity value, and adjusting the first blur radius and the first blur opacity value to a second blur radius and a second blur opacity value.

10. The method of claim 1, wherein responsive to the switching event trigger signal, the method further comprises:
animating a zoom to a crop of an object of interest in a media asset of the media presentation while rotating the media player view.

11. A system comprising:
one or more processors;
memory coupled to the one or more processors and configured to store instructions, which, when executed by the one or more processors, cause the one or more processors to perform operations comprising:
obtaining a first set of instructions for playing a media presentation in a first format, the the first format including a first composition of media assets based on a first orientation view;
playing, by a media player, the media presentation in a media player view in the first format according to the first set of instructions;
obtaining a switching event trigger signal indicating a change in orientation of the system;
responsive to the switching event trigger signal:
obtaining a second set of instructions for playing the media presentation in a second format, the second format including a second composition of media assets that is different than the first composition of media assets, the second composition of media assets based on a second orientation view that is different than the first orientation view; and
playing, by the media player, the media presentation in the media player view in the second format according to the second set of instructions.

12. (canceled)

13. The system of claim 11, wherein the switching event trigger signal is a change in size or aspect ratio of the media player view.

14. The system of claim 11, wherein the first or second set of instructions include instructions for at least one of framing, animating or applying special effects to at least one media asset in the media presentation.

15. The system of claim 14, wherein the first or second set of instructions include framing instructions for using metadata or unions of spatial regions in the at least one media asset to position an object of interest in the at least one media asset in a composition for display in the media player view.

16. The system of claim 14, wherein the first or second set of instructions include framing instructions for using metadata or unions of spatial regions in two or more media assets to determine a potential for combining the two or more media assets in the media player view.

17. The system of claim 16, wherein the potential for combining the two or more media assets in the media player view includes the potential to display the two or more media assets side-by-side in the media player view.

18. The system of claim 11, wherein the first or second set of instructions include animating instructions for animating one or more media assets of the media presentation to highlight an object of interest in the one or more media assets.

19. The system of claim 11, wherein responsive to the switching event trigger signal the operations further comprise:
generating a snapshot of the media player view;
compositing the snapshot on the media player view, the snapshot having a first snapshot opacity value operable to at least partially obscure the media player view;
generating a blur layer, the blur layer having a first blur radius and a first blur opacity value;
compositing the blur layer on the snapshot;
rotating and scaling the composite of the player view, the snapshot and the blur layer; and
during the rotating and scaling, adjusting the first snapshot opacity value to a second snapshot opacity value, and adjusting the first blur radius and the first blur opacity value to a second blur radius and a second blur opacity value.

20. The system of claim 11, wherein responsive to the switching event trigger signal the operations further comprise:
animating a zoom to a crop of an object of interest in a media asset of the media presentation while rotating the media player view.
